(19) United States
(12) Patent Application Publication
(10) Pub. No.: US 2026/0229826 A1
(43) Pub. Date: Aug. 6, 2026

(54) High-Power Connection Socket And High-Voltage Distribution Unit Having A Corresponding High-Power Connection Socket

(71) Applicant: Eugen Forschner GmbH, Spaichingen (DE)

(72) Inventors: Bianca Bruning, Spaichingen (DE); Martin Dopadlo, Spaichingen (DE)

(73) Assignee: Eugen Forschner GmbH, Spaichingen (DE)

(21) Appl. No.: 19/530,987

(22) Filed: Feb. 5, 2026

(30) Foreign Application Priority Data
Feb. 6, 2025 (DE) 102025104451.1

(51) Int. Cl. H01R 13/74

(52) U.S. Cl. CPC H01R 13/74; H01R 2201/26

(57) ABSTRACT

A high-power connection socket for megawatt coupling, in particular for an electric vehicle, includes: a connection element having a plurality of contact pin receptacles; a circumferential collar which is formed around the connection element and laterally surrounds the connection element. Here, the circumferential collar is formed integrally with a wall of a housing of a high-voltage distribution unit and extends perpendicularly outwards from the wall, wherein the connection element can be plugged into the circumferential collar and can be fastened to the wall. Furthermore, A high-voltage distribution unit has a corresponding high-power connection socket.

### CROSS-REFERENCE TO RELATED APPLICATIONS

This application claims priority to German Patent Application No. DE 10 2025 104 451.1, filed Feb. 6, 2025, the entire disclosure of which is incorporated herein by reference.

### FIELD OF THE INVENTION

The invention relates to a high-power connection socket for megawatt coupling, in particular for an electric vehicle.

Furthermore, the invention relates to a high-voltage distribution unit for energy distribution and/or energy conversion and/or energy protection in a vehicle having a corresponding high-power connection socket.

### BACKGROUND OF THE INVENTION

Connection sockets for charging electric vehicles are known in the prior art. The transformation of internal combustion vehicles into electric vehicles for reducing the dependence on fossil fuels and for promoting sustainability in the transport sector has also led to the fact that the provision of efficient and versatile charging possibilities is of crucial importance. This applies in particular to vehicles which are used in the industrial and commercial sector, in which time and power are of crucial importance.

Against this background, efforts have been made to provide high-power connection sockets which allow a charging power in the megawatt range. In this case, a standard connection specification or connection socket specification has also been developed within the framework of the megawatt charging system MCS. The new megawatt charging system MCS, with its higher charging power, opens up the possibility of electric mobility in a number of very different vehicles. As a result, heavy commercial vehicles, special vehicles, maritime vehicles or aircraft can also be formed as electric vehicles.

However, the connection sockets known from the prior art are currently not suitable for such a diverse application.

### BRIEF SUMMARY OF THE INVENTION

The invention relates to specifying an advantageous high-power connection socket for megawatt coupling.

Furthermore, an aspect of the present invention relates to an advantageous high-voltage distribution unit.

The solution according to an aspect of the invention consists in particular in specifying a high-power connection socket for megawatt coupling, in particular for an electric vehicle. The high-power connection socket has a connection element having a plurality of contact pin receptacles, in particular having corresponding contact pins. Furthermore, the high-power connection socket has a circumferential collar which is formed around the connection element and laterally surrounds the connection element.

According to an embodiment of the invention, the circumferential collar is formed integrally with a wall of a housing of a high-voltage distribution unit. Here, the circumferential collar preferably extends at least substantially perpendicularly outwards from the wall.

The high-power connection socket is arranged on the high-voltage distribution unit of the vehicle such that the high-power connection socket is accessible from outside the vehicle. A charging connector of an external charging station can be inserted into the high-power connection socket in order to charge the vehicle at high power levels in the megawatt range.

Accordingly, the high-power connection socket is configured specifically for charging the vehicle and not merely for distributing electrical energy between internal vehicle components. The insertion of the charging connector into the high-power connection socket establishes an electrical charging connection between the external charging station and the high-voltage system of the vehicle.

The connection element can be plugged into the circumferential collar and can be fastened or is fastened to the wall.

The high-power connection socket is a connection socket which is designed to receive or output power in the megawatt range. For example, the high-power connection socket can be a connection socket which is designed to receive a charging power.

In particular, the high-power connection socket is suitable at least for a power of 1 megawatt, preferably between 2 and 4.5 megawatts. Furthermore, the high-power connection socket is preferably suitable for a rated current of up to 300 amperes and a rated voltage of up to 1500 volts DC voltage.

The connection element is preferably an integral, in particular integrally formed, element in which all the contact pin receptacles of the high-power connection socket are arranged centrally. The contact pin receptacles are designed to receive contact pins for establishing an electrical contact.

The plurality of contact pins comprises power contact pins for transferring high charging currents, preferably two DC contact pins, at least one protective earth contact pin for electrical safety, and one or more communication contact pins configured to enable charging communication between the external charging station and the vehicle.

Accordingly, the plurality of contact pins receptacles comprises power contact pins receptacles, preferably two DC contact pin receptacles, at least one protective earth contact pin receptacle, and one or more communication contact pin receptacles.

Particularly preferably, the contact pin receptacles comprise two DC contact pin receptacles, one protective earth conductor contact pin receptacle, one communication line receptacle, one PP (proximity pilot) contact pin receptacle and one CP (control-pilot) contact pin receptacle.

Independently thereof, the contact pin receptacles extend through the connection element in the axial direction.

The circumferential collar is preferably an at least substantially annular edge which is formed surrounding the connection element. The collar is thus formed around the connection element. The collar is designed at least to protect the connection element from lateral impacts. Furthermore, the collar can protect the connection element or the contact pins which can be arranged in the connection element in general from external influences such as dust, moisture or mechanical loading. The at least substantially annular edge of the collar is formed by means of a circumferential wall. The circumferential wall is preferably formed complementary to a mantle surface of the connection element.

For example, the mantle surface of the connection element has three rounded corners. Accordingly, the circumferential wall then likewise has three rounded corners.

Since according to an embodiment of the invention, the collar is formed as an integral element with the wall of the housing of the high-voltage distribution unit, sealing is only required between the connection element and the circumferential collar. The high-power connection socket is accordingly easy to seal and has a high degree of mechanical robustness.

The high-voltage distribution unit is a device for energy distribution and/or energy conversion and/or energy protection in a vehicle. The high-voltage distribution unit is also referred to as a PDU (power distribution unit) and has a plurality of high-voltage components which are operated by means of high voltage, also referred to as HV.

In particular, the high-voltage distribution unit preferably has at least two busbars, one for a positive and one for a negative high-voltage potential. Particularly preferably, the distribution unit comprises a plurality of busbars. Furthermore, the high-voltage distribution unit preferably comprises signal lines for the communication connection and optionally cooling devices for cooling the busbars or the high-voltage components installed in the high-voltage distribution unit.

Particularly preferably, the high-voltage distribution unit is connected or can be connected to a voltage source, in particular a (HV) vehicle battery, and is connected or can be connected to a plurality of consumers. The high-voltage distribution unit is therefore in particular not the (HV) vehicle battery. In this case, the high-voltage distribution unit serves to transmit energy from the voltage source to a plurality of consumers. The individual consumers can be connected and disconnected separately by means of the high-voltage distribution unit. The switching elements are arranged as high-voltage components as part of the high-voltage distribution unit in the housing and can be designed, for example, electromechanically, in particular as a contactor, but in principle also purely electronically with power semiconductors.

In summary, the high-voltage distribution unit is designed at least for energy distribution. In this case, the high-voltage distribution unit comprises a plurality of busbars and switching devices for connecting or disconnecting individual branches or consumers.

Furthermore, the high-voltage distribution unit can optionally comprise a DC-DC converter. The DC-DC converter is adapted, for example, to convert the HV DC voltage into an on-board electrical system voltage of the vehicle. Further converters can be integrated in the high-voltage distribution unit.

According to an advantageous development of the invention, the circumferential collar is integrally formed together with the wall.

The circumferential collar is thus produced together with the wall in a uniform production process as a continuous, seamless component. In this case, the collar and the wall preferably consist of the same material and are produced without subsequent assembly or connecting steps. For example, the primary forming is carried out by injection molding or die casting or a comparable method.

The primary formed connection ensures maximum stability and material homogeneity. The method of production ensures a high degree of mechanical robustness and improved sealing.

In an alternative embodiment, the circumferential collar is cast into the wall. Alternatively, the circumferential collar is therefore cast into the wall during production. In this case, the collar is either produced separately and then connected to the wall during the casting process or is embedded firmly in the material of the wall in a second step. A strong mechanical connection between collar and wall can also be produced by this method.

The advantage of the cast-in collar is that there is greater flexibility in the selection of materials, with the result that the collar and the wall can be matched optimally to different requirements.

Accordingly, an advantageous development of this embodiment provides that a material forming the circumferential collar differs from a material forming the wall. Here, the material of the collar is preferably harder than the material of the wall. For example, the material of the collar is aluminum or a fiber-reinforced plastic. Particularly preferably, the fiber-reinforced plastic is glass-fiber-reinforced or carbon-fiber-reinforced plastic.

This creates a particularly robust and shape stable circumferential collar, by means of which the connection element can be arranged in the wall in a well-protected manner.

According to an advantageous development of the invention, the connection element is detachably fastened and in particular screwed to the wall.

The connection element is thus designed such that it can be detachably fastened to the wall. Accordingly, the connection element can be easily disassembled or replaced if necessary without impairing the wall and the collar. Preferably, the fastening is carried out by means of a screw connection. For this purpose, corresponding threads or bores are provided on the wall and the connection element.

As a result of the detachable fastening, the overall construction of the system becomes more maintenance-friendly and adaptable without impairing the safety and reliability of the connection.

In an advantageous development of the invention, the connection element has an, in particular circumferential, fastening flange for preferably detachable fastening to the wall.

The fastening flange preferably extends laterally circumferentially from a lower end of the connection element. It extends in particular annularly around the connection element and ensures a uniform distribution of the mechanical forces and a stable fastening in a connection.

By means of the circumferential flange, it is furthermore easily possible to integrate a seal and to ensure the sealing of the system.

The collar encloses an opening in the wall, into which the connection element is inserted from an interior of the high-voltage distribution unit. The flange is then fastened, in particular screwed, to the wall from the inside. Alternatively thereto, laser welding would of course also be possible.

In an advantageous development of this embodiment, the fastening flange comprises a plurality of fastening bores arranged in such a way that the connection element can be uniquely positioned in the collar.

The fastening bores are therefore configured in such a way that the connection element can be inserted into the collar and fastened to the wall only in a unique and correct manner. In this case, the bores are arranged in a specific geometry. In particular, the bores are arranged asymmetrically or at different distances, with the result that the connection element can be connected to the wall only in the intended orientation. This arrangement prevents incorrect assembly since the connection element cannot be fastened in an incorrect orientation.

According to an advantageous development of the invention, the collar projects axially beyond the connection element in the assembled state.

In other words, when assembled, the collar is designed to extend axially beyond the connection element, i.e., it protrudes outward beyond it. The collar thus projects in the longitudinal direction along the axis of the connection element beyond the outer surface or the outer end of the connection element. As a result of this axial projection, the collar offers an additional protective function for the connection element by shielding the connection element from mechanical loadings, impact effects or environmental influences. The connection element is thus protected from external influences by the protruding collar, in particular at the contact points or sensitive components.

In an advantageous development of the invention, a sealing device is arranged between the connection element and the wall.

The sealing device enables reliable sealing of the interface between the connection element and the wall. The sealing device is located between the outer surface of the connection element and the adjacent surface of the wall. Particularly preferably, the sealing device is designed as a flat seal, in particular an elastomer profile seal or O-ring seal.

The seal can ensure that the interior of the high-voltage distribution unit remains securely protected from external influences. Particularly preferably, the sealing device is thus clamped between the connection element and the wall as a planar sealing device.

The solution according to the invention furthermore consists in specifying a high-voltage distribution unit for energy distribution and/or energy conversion and/or energy protection in a vehicle. In this case, the high-voltage distribution unit comprises: a plurality of high-voltage components which are operated by means of high voltage, wherein the high-voltage components preferably comprise at least a plurality of high-voltage busbars and high-voltage switching devices for connecting or disconnecting individual high-voltage busbars. Furthermore, the high-voltage distribution unit comprises a housing which encloses the high-voltage components, wherein the housing has a wall. Furthermore, the high-voltage distribution unit comprises one of the high-power connection sockets described above.

Since the high-voltage distribution unit comprises one of the high-power connection sockets described above, all individual aspects and advantages of the high-power connection sockets can be transmitted to the high-voltage distribution unit. In particular, the high-voltage distribution unit is therefore a high-voltage device for energy distribution.

The high-power connection socket forms a charging interface that is accessible to an external charging connector, such that the charging process can be initiated from outside the vehicle. The high-voltage distribution unit thus serves not only as an internal distribution component but also as an interface for supplying electrical energy in the megawatt-range to the vehicle during a charging operation.

During a charging operation, the high-voltage distribution unit electrically couples the high-power connection socket to at least one internal high-voltage component, e.g. a high-voltage (HV) battery, of the vehicle, such that electrical energy supplied via the charging connector is distributed within the vehicle starting from the high-power connection socket.

Preferably, the high-voltage distribution unit is designed to connect the high-voltage (HV) battery formed separately from the high-voltage distribution unit to different consumers. The high-voltage distribution unit is therefore a technical system of the vehicle. In the vehicle, it serves to distribute, convert and/or protect high-voltage energy. Optionally, the high-voltage distribution unit can also perform energy conversion functions, for example converting direct current into alternating current or direct current into direct current. In the case of energy protection, the high-voltage distribution unit serves to protect the vehicle from overloads, short circuits or other malfunctions by means of the integrated switching devices.

The high-voltage distribution unit comprises the housing that encloses the high-voltage components. The housing is configured as a closed housing that shields the enclosed high-voltage components from the external environment. The high-power connection socket is arranged in a wall of the housing and provides the interface for an external charging connector. The wall faces outward toward the exterior of the vehicle so as to be accessible for insertion of the external charging connector.

The housing does preferably not accommodate a high-voltage battery. Instead, the housing encloses the high-voltage components for distributing and switching electrical energy, in particular busbars and one or more high-voltage switching devices.

The high-voltage connection socket according to the invention enables a safe and powerful coupling of the high-voltage distribution unit to external high-voltage systems.

### BRIEF DESCRIPTION OF THE DRAWINGS

The above-described, different and exemplary features can be combined with one another according to the invention, insofar as this is technically meaningful and suitable. Further features, advantages and embodiments of the invention emerge from the following description of exemplary embodiments and with reference to the figures.

The figures used to explain the exemplary embodiments show:

FIG. 1 a perspective view of a high-power connection socket in a wall of a high-voltage distribution unit.

FIG. 2 an exploded view of the high-power connection socket shown in FIG. 1; and

FIG. 3 a sectional view of the high-power connection socket shown in FIG. 1.

### DETAILED DESCRIPTION

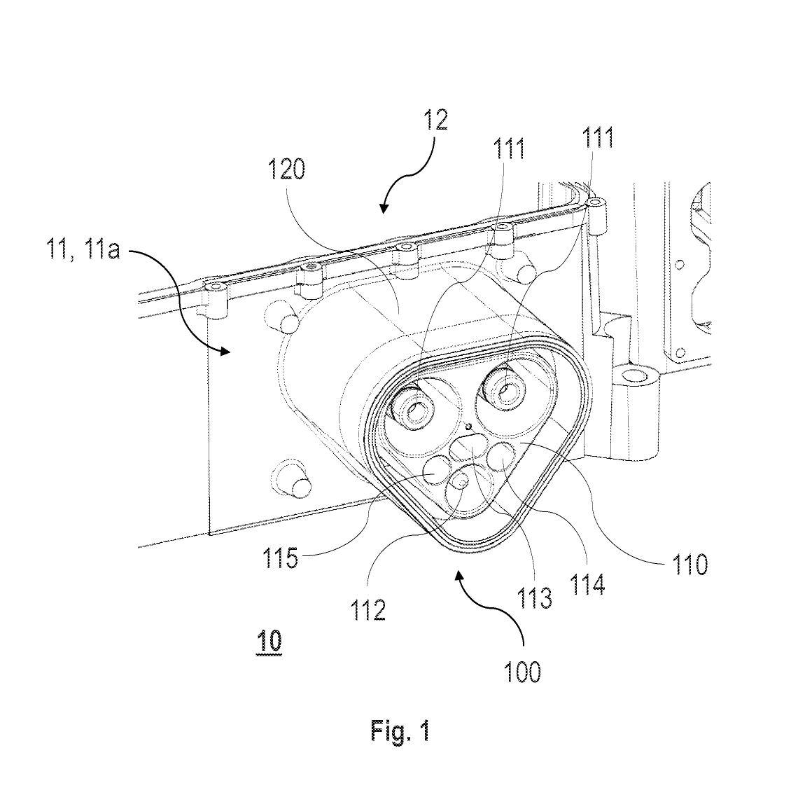

FIG. 1 shows a high-power connection socket which serves for megawatt coupling of a high-voltage distribution unit 10. The high-voltage distribution unit 10 has a plurality of high-voltage components indicated by reference number 12. The high-voltage components 12 are very generally components operated with high voltage. In particular, these may be high-voltage busbars and high-voltage switching devices for connecting and disconnecting the individual high-voltage busbars.

The high-voltage distribution unit 10 comprises a housing 11. Of the housing 11, in particular a wall 11a is shown in FIG. 1, in which the high-power connection socket 100 is also located.

The high-power connection socket 100 has two main elements, specifically a connection element 110 and a circumferential collar 120. The connection element 110 is arranged in a region protected and completely surrounded by the circumferential collar 120. The connection element 110 has a plurality of contact pin receptacles 111, 112, 113, 114 and 115.

A high-power plug, for example a high-power charging plug, can be plugged into the high-power connection socket 100.

In FIG. 1, the individual contact pin receptacles 111 to 115 of the connection element 110 of the high-power connection socket 100 can be seen particularly well. In this case, the connection element 110 comprises two DC contact pin receptacles 111, a protective earth conductor contact pin receptacle 112, a communication line contact pin receptacle 113, a PP contact pin receptacle 114 and a CP contact pin receptacle 115.

In the specification shown, the high-power connection socket 100 is designed with a coupling power of up to 4.5 megawatts.

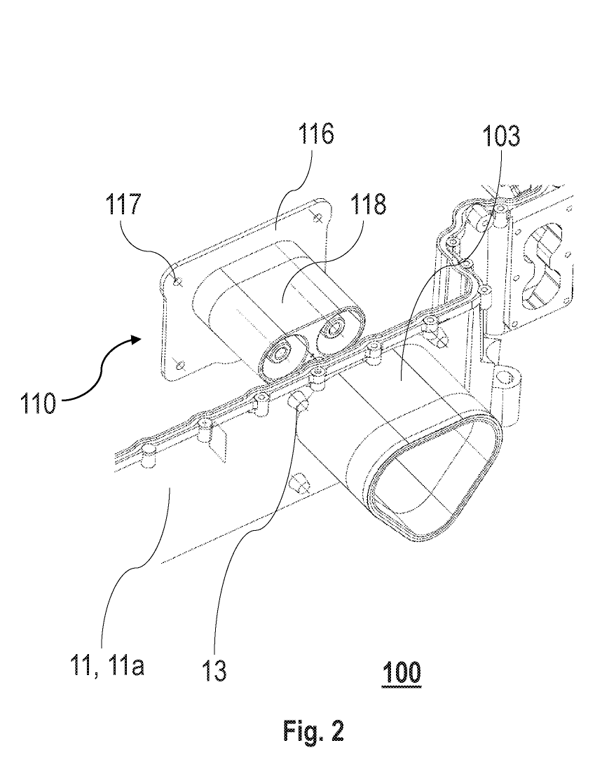

The collar 120 and the connection element 110 are two separate components. This can also be seen clearly in particular in FIG. 2. Here, the collar 120 is formed integrally with the wall 11a of the housing 11. The collar 120 extends perpendicularly outwards from the wall 11a and thus surrounds the connection element 110 which likewise extends perpendicularly outwards. In the assembled state shown in FIG. 1, in which the connection element 110 is inserted into the collar 120, the collar projects axially beyond the connection element 110.

This means that the collar 120 extends further outwards from the wall 11a than the connection element 110.

As can be seen in particular in FIG. 2, the connection element 110 has a fastening flange 116 and a region 118 protruding from the fastening flange 116. The contact pin receptacles 111 to 115 are arranged in the protruding region 118.

As can be seen in FIG. 2, the protruding region 118 is also the region which is inserted into the collar 120. The fastening flange 116 is arranged completely circumferentially on the protruding region 118. In this case, the fastening flange 116 is at least substantially plate-shaped.

The fastening flange 116 comprises a plurality of fastening devices, in particular fastening bores 117. The fastening bores 117 are formed so as to match fastening means

receptacles 13 in the wall 11a. If the fastening bores 117 are arranged so as to be aligned with the fastening means receptacles 13, fastening means such as, for example, screws can be inserted into the fastening means receptacles 13 formed as threads.

Here, the fastening bores 117 and the fastening means receptacles 13 are preferably arranged in such a way that the connection element 110 can be uniquely positioned in the collar 120. The fastening bores 117 and the fastening means receptacles 13 are therefore only aligned with each other in the intended position of the connection element 110 relative to the collar 120. The fastening means receptacles 13 are preferably receptacles formed in the wall 11a.

Particularly preferably, these receptacles project perpendicularly from the rest of the wall 11a, as shown in FIG. 2. Thus, the wall 11a can be formed to be thin and nevertheless enable a sufficiently stable reception of the fastening means.

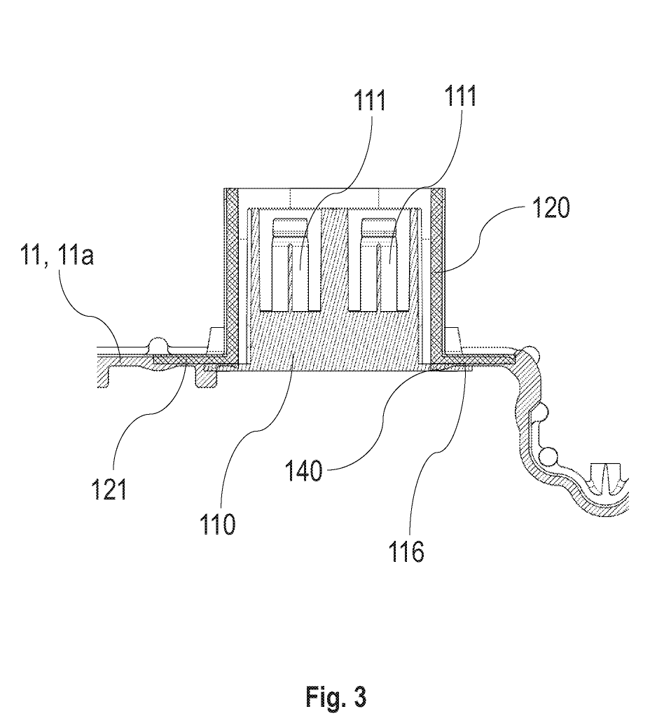

FIG. 3 shows a sectional view of the high-power connection socket 100 shown in FIGS. 1 and 2.

In this case, the connection element 110 is inserted into the collar 120 and fastened to the wall 11a. In particular, the two DC contact pin receptacles 111 can be seen in the connection element 110. In the example shown in FIG. 3, the circumferential collar 120 is cast into the wall 11a. Alternatively thereto, it would also be conceivable for the circumferential collar 120 to be integrally formed together with the wall 11a. Here, the circumferential collar 120 has a flange 121. The flange 121 ensures that the collar 120 forms a large-area contact with the wall 11a.

As can be seen in FIG. 3, the material forming the circumferential collar 120 differs from the material of the wall 11a. Thus, the collar 120 can be formed, for example, from a particularly hard material such as, for example, fiber-reinforced plastic. The flange 121 of the circumferential collar 120 is formed at least substantially parallel to the fastening flange 116 of the connection element 110.

A planar sealing device 140 is indicated between the fastening flange 116 and the wall 11a. The sealing device 140 serves to seal the interface between the connection element 110 and the wall 11a.

### REFERENCE SIGNS

10 High-voltage distribution unit

11 housing

11a wall

12 high-voltage components

13 fastening means receptacles

100 high-power connection socket

110 connection element

111 DC contact pin receptacles

112 protective earth conductor contact pin receptacle

113 communication line contact pin receptacle.

114 PP contact pin receptacle

115 CP contact pin receptacle

116 fastening flange

117 fastening bore

118 protruding region

120 circumferential collar

121 flange (of the circumferential collar)

140 sealing device

1. A high-power connection socket for megawatt coupling, the connection socket comprising:
a connection element having a plurality of contact pin receptacles;
a circumferential collar formed around the connection element and laterally
surrounding the connection element, wherein
the circumferential collar is formed integrally with a wall of a housing of a high-voltage distribution unit and extends perpendicularly outwards from the wall, wherein the connection element is configured to be plugged into the circumferential collar and to be fastened to the wall.

2. The high-power connection socket according to claim 1,
wherein
the circumferential collar is integrally formed together with the wall.

3. The high-power connection socket according to claim 1,
wherein
the circumferential collar is cast into the wall.

4. The high-power connection socket according to claim 3,
wherein
a material forming the circumferential collar differs from a material forming the wall.

5. The high-power connection socket according to claim 1, wherein the connection element is detachably fastened to the wall.

6. The high-power connection socket according to claim 1, wherein the connection element comprises a fastening flange for fastening to the wall.

7. The high-power connection socket according to claim 6,
wherein the fastening flange comprises a plurality of fastening bores arranged in such a way that the connection element is uniquely positioned in the collar.

8. The high-power connection socket according to claim 1, wherein the collar projects axially beyond the connection element in an assembled state.

9. The high-power connection socket according to claim 1, further comprising:
a sealing device arranged between the connection element and the wall.

10. A high-voltage distribution unit for energy distribution and/or energy conversion and/or energy protection in a vehicle, wherein the high-voltage distribution unit comprises:
a plurality of high-voltage components configured to be operated by high voltage, wherein the high-voltage components comprise at least a plurality of high-voltage busbars and high-voltage switching devices for connecting or disconnecting individual high-voltage busbars,
a housing enclosing the high-voltage components, wherein the housing has a wall, and
a high-power connection socket according to claim 1.

11. The high-power connection socket according to claim 6 wherein the fastening flange is a circumferential flange and is configured to be detachably fastened to the wall.

12. The high-power connection socket according to claim 5, wherein the connection element is screwed to the wall.

13. The high-power connection socket according to claim 4, the material of the collar is harder than the material of the wall.
